(19) United States
(12) Patent Application Publication
(10) Pub. No.: US 2016/0132180 A1
(43) Pub. Date: May 12, 2016

(54) Capacitive Touch Circuit and Touch Sensor and Capacitive Touch System Using The Same

(71) Applicants: APEX MATERIAL TECHNOLOGY CORP., Keelung City (TW); IMAGINATION BROADWAY LTD., NEW TAIPEI CITY (TW)

(72) Inventors: PING-JUNG KAO, KEELUNG (TW); I-TE LIN, KEELUNG (TW)

(21) Appl. No.: 14/539,240

(22) Filed: Nov. 12, 2014

(51) Int. Cl. G06F 3/041; G06F 1/16; G06F 3/044

(52) U.S. Cl. CPC G06F 3/0418; G06F 3/044; G06F 1/16; G06F 2203/04101

(57) ABSTRACT

A capacitive touch system including a capacitive touch sensor and a controller is provided. The sensor includes a first and a second substrate, a first and a second electrode arrangement, and a floating electrode arrangement. The first electrode arrangement and the floating electrode arrangement are disposed on different parts of the first substrate. The first and the second electrode arrangements are used to produce an electric field. A change in the characteristic of the electric field occurs when the touch sensor is touched. The floating electrode arrangement has multiple insulation slits for the electric field to pass through. The first and the floating electrode arrangements are electrically insulated through the slits, and multiple floating electrode units in the floating electrode arrangement are also electrically insulated from one another through the slits. The controller outputs a control signal based on the change in the characteristic of the electric field.

### RELATED APPLICATIONS

This application claims priority to Taiwan patent application, No. 103116103, filed on May 6, 2014, entitled “CAPACITIVE TOUCH CIRCUIT AND TOUCH SENSOR AND CAPACITIVE TOUCH SYSTEM USING THE SAME”, which is hereby incorporated by reference in its entirely.

### BACKGROUND OF THE INVENTION

1. Technical Field

The present invention relates to a capacitive touch circuit. More particularly, the present invention relates to a capacitive touch sensing circuit using a projected electric field.

2. Description of Related Art

There are various types of touch panels in the market, including capacitive, resistive, optical, electromagnetic, and acoustic wave touch panel. Among these types of touch panels, the capacitive touch panel has the merits including high transparency, good responsiveness, accurate touch sensing, multi-touch compatibility, and compact package size, and therefore has been widely used in products of various sizes. In addition to that, the capacitive touch panel is also characterized in increased durability and good fire, scratch, and stain resistances.

The capacitive touch panel requires a transparent capacitive touch sensing circuit in order to detect the capacitance value. When a user's finger or a capacitive stylus touches or is in proximity to the detection area of the capacitive panel, the capacitance value changes. The sensing circuit detects the change of the capacitance value and then the touch panel determines the touch location accordingly. Generally, there are two kinds of sensing method to detect the capacitance value in the capacitive touch panel, one is called self-capacitance sensing and the other is mutual-capacitance sensing. The signal source of the self-capacitance sensing method is the increment of capacitance brought in from the finger (or the stylus). In the self-capacitance sensing method, when the user touches the panel, the capacitance of the sensing electrode (sensor) at the touch location is increased because the finger brings in additional capacitance. On the other hand, in addition to the sensing electrode, the mutual-capacitance sensing method further requires a driving electrode (driver). The driving electrode provides a voltage level which is different from the one provided by the sensing electrode, and an electric field is therefore generated between the two electrodes. As the finger touches or is in the proximity of the touch panel, the intensity of the electric field is affected and the capacitance value is shifted. The capacitance value shifting is taken as the signal source of the mutual-capacitance sensing method. Typically, a mutual-capacitance touch panel includes two layers of electrodes, and the layers are distributed spatially. The electric field is generated between the two layers of electrodes, and the touch signal is generated by detecting the change of the electric field.

The spatially distributed layers of electrodes generally include one upper layer and one lower layer to form a touch sensing circuit, and each layer is formed by an array of electrodes. The lower layer is the driving circuit which projects electric field to the upper layer, and the upper layer is the sensing layer. However, in such kind of upper-and-lower layer disposition, the upper layer would at least partially overlap the lower layer. As a result, the driving signal of the lower layer would be affected by the upper sensing layer and the sensing signal would also be affected by other signal levels. This would lead to inaccurate reading of the touch signal and lowering the accuracy of determining the touch location.

### SUMMARY

A capacitive touch circuit, a capacitive touch sensor and a capacitive touch system using the same are provided to solve the problems of inaccurate reading of touch signal and lowering the accuracy of determining the touch location.

According to one aspect of the invention, the capacitive touch circuit includes a first electrode, a second electrode and a floating electrode. The first electrode is disposed on a partial surface of a first substrate, and the second electrode is disposed on a partial surface of a second substrate. The first and the second electrodes are used to produce an electric field. The floating electrode is disposed on another partial surface of the first substrate and at least partially overlaps the second electrode in a projection direction. The floating electrode includes one or more insulation slits and several floating electrode units. The first electrode is electrically insulated from the floating electrode through the insulation slits, and the floating electrode units are electrically insulated from one another through the insulation slits. The electric field passes through the insulation slits.

In the foregoing capacitive touch circuit, the floating electrode units are arranged symmetrically along a central axis of the floating electrode.

In the foregoing capacitive touch circuit, the first electrode is arranged in a first axial direction, and the second electrode is arranged in a second axial direction. The first axial direction is not parallel to the second axial direction, yet the second axial direction is parallel to the central axis.

In the foregoing capacitive touch circuit, the floating electrode units have the same area size with one another.

In the foregoing capacitive touch circuit, the intensities of the electric field passing through adjacent insulation slits are different.

In the foregoing capacitive touch circuit, the floating electrode is formed by dry etching, exemplarily a laser cutting process.

In the foregoing capacitive touch circuit, the first electrode and the floating electrode are made of the same conductive material.

In the foregoing capacitive touch circuit, the first electrode and the second electrode are made of different materials.

According to another aspect of the invention, the capacitive touch sensor includes a first substrate, a first electrode arrangement, a second substrate, a second electrode arrangement and a floating electrode arrangement. The first electrode arrangement is disposed on a part of a first surface of the first substrate. The second electrode arrangement is disposed on a second surface of the second substrate, which faces the first substrate, for producing an electric field with the first electrode arrangement. The floating electrode arrangement is disposed on another part of the first surface and at least partially overlaps the second electrode arrangement in a projection direction. The floating electrode arrangement has a number of insulation slits, and the electric field passes through the slits. The floating electrode arrangement is electrically insulated from the first electrode arrangement through the slits. Each floating electrode in the floating electrode arrangement includes a number of floating electrode units. The floating electrode units are electrically insulated from one another through the slits.

In the forgoing capacitive touch sensor, the floating electrode units are arranged symmetrically along a central axis of each floating electrode.

In the foregoing capacitive touch sensor, each first electrode in the first electrode arrangement is arranged in a first axial direction and each second electrode in the second electrode arrangement is arranged in a second axial direction. The first axial direction is not parallel to the second axial direction, yet the second axial direction is parallel to the central axis.

In the foregoing capacitive touch sensor, the floating electrode units have the same area size with one another.

In the foregoing capacitive touch sensor, the intensities of the electric field passing through adjacent insulation slits are different.

In the foregoing capacitive touch sensor, the insulation slits are formed by dry etching, exemplarily a laser cutting process.

In the foregoing capacitive touch sensor, the first electrode arrangement and the floating electrode arrangement are made of the same conductive material.

In the foregoing capacitive touch sensor, the first electrode arrangement and the second electrode arrangement are made of different materials.

According to yet another aspect of the invention, the capacitive touch system includes a capacitive touch sensor and a controller. The capacitive touch sensor includes a first substrate, a first electrode arrangement, a second substrate, a second electrode arrangement, and a floating electrode arrangement. The first electrode arrangement is disposed on a part of a first surface of the first substrate. The second substrate has a second surface facing the first substrate. The second electrode arrangement is disposed on the second surface for producing an electric field with the first electrode arrangement. A change in the characteristic of the electric field occurs when the capacitive touch sensor is touched. The floating electrode arrangement is disposed on another part of the first surface and at least partially overlaps the second electrode arrangement in a projection direction. The floating electrode arrangement has a number of insulation slits, and the electric field passes through the slits. The floating electrode arrangement is electrically insulated from the first electrode arrangement through the slits. The floating electrode arrangement includes a number of floating electrode units that are electrically insulated from one another through the insulation slits. The controller is electrically connected to the capacitive touch sensor and is used to output a control signal based on the change in the characteristic of the electric field.

According to the above-mentioned disclosure, in the capacitive touch circuit, sensor and system provided in the invention, the problems of inaccurate reading of touch signal and lowering the accuracy of determining the touch location are solved by way of having the electric field pass through the insulation slits. The phenomena that the lower driving signal being affected by the upper sensing signal and the upper sensing signal being affected by other signal levels can be avoided. The sensing signal can therefore be enhanced and the accuracy of touch signal can be improved as well.

It is to be understood that both the foregoing general description and the following detailed description are by examples, and are intended to provide further explanation of the invention as claimed.

### BRIEF DESCRIPTION OF DRAWINGS

The invention can be more fully understood by reading the following detailed description of the embodiment, with reference made to the accompanying drawings as follows:

FIG. 1 is a perspective view of a capacitive touch system according to one embodiment of the invention;

FIG. 2 is a partial side-view of the capacitive touch circuit according to one embodiment of the invention;

FIG. 3 is a partial top-view of the first electrode arrangement and the floating electrode arrangement of FIG. 1; and

FIG. 4 is a partial top-view of the first electrode arrangement and the floating electrode arrangement according to another embodiment of the invention.

### DETAILED DESCRIPTION

Reference will now be made in detail to elaborate the contents, features and results of the present embodiments of the invention, examples of which are illustrated in the accompanying drawings. The directional terms in the detailed description, e.g. “upper”, “lower”, “upwardly”, “top” and “bottom”, and the number of elements, are used for the purpose of clarity, and are not intend to limit the scope of the invention.

In the embodiments of the present invention, a capacitive touch circuit, a capacitive touch sensor and a capacitive touch system are disclosed.

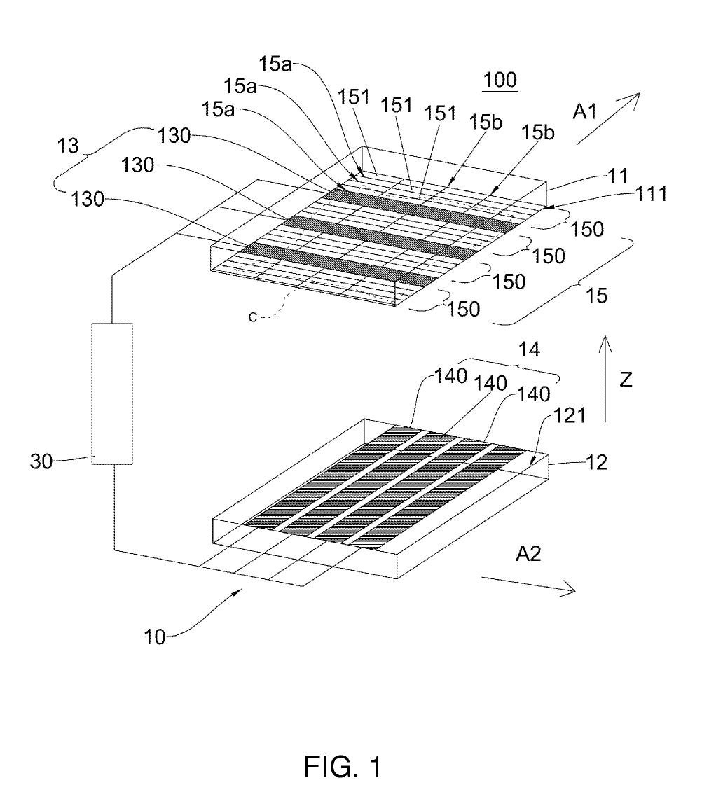

Please refer to FIG. 1, which is a perspective view of a capacitive touch system according to one embodiment of the invention. The capacitive touch system 100 includes a capacitive touch sensor 10 and a controller 30. The controller 30 is electrically connected to the capacitive touch sensor 10 for outputting signals to and receiving signals from the capacitive touch sensor 10.

The capacitive sensor 10 of the present embodiment includes a first substrate 11, a second substrate 12, a first electrode arrangement 13, a second electrode arrangement 14, and a floating electrode arrangement 15. The first substrate 11 has a first surface 111. The first electrode arrangement 13 is disposed on the first surface 111 and covers only a part of the first surface 111. The second substrate 12 has a second surface 121 that faces the first substrate 11. The second electrode arrangement 14 is disposed on the second surface 121 with a partial coverage as well. In the present embodiment, the first substrate 11 and the second substrate 12 are disposed in parallel, and they are made of a same transparent material. For example, the two substrates 11, 12 are both made of glass. Other suitable transparent materials can also be used here and are not limited in the present invention.

The floating electrode arrangement 15 is also disposed on the first surface 111 of the first substrate 11, yet it covers another part of the first surface 111 other than the part covered by the first electrode arrangement 13. To be more specific, the first electrode arrangement 13 and the floating electrode arrangement 15 are disposed on the first surface 111 concurrently without overlapping or overlaying each other. The floating electrode arrangement 15 at least partially overlaps the second electrode arrangement 14 in a projection direction Z. In the present embodiment, the projection direction Z is the upright direction of the first substrate 11 and the second substrate 12, as shown in FIG. 1. The floating electrode arrangement 15 includes more than one floating electrode units 151 and is provided with a number of insulation slits 15a, 15b. The floating electrode arrangement 15 is electrically insulated from the first electrode arrangement 13 through the insulation slits 15a, 15b. Besides that, the floating electrode units 151 are also electrically insulated from one another through the insulation slits 15a, 15b.

In one embodiment, the first electrode arrangement 13 and the floating electrode arrangement 15 are made of a same conductive material and are formed on the first surface 111 of the first substrate 11 in the same manufacturing step. The conductive material is a transparent conductive material which can be exemplified by (but not limit to) nano metal wire, Indium Tin Oxide (ITO), Zinc Oxide (ZnO), Indium Zinc Oxide (IZO), Aluminum Zinc Oxide (AZO), Gallium Zinc Oxide (GZO), or nano carbon tubes. In another embodiment, the conductive material can also be opaque materials, for example high electrical conductivity metal like silver, copper, and gold. Although both the transparent and opaque materials are applicable, the transparent material is preferable in the present embodiment of the invention. The insulation slits 15a, 15b are formed by dry etching; for example, laser cutting the transparent conductive material to form the first electrode arrangement 13 and the floating electrode arrangement 15. As for the material of the second electrode arrangement 14 in the present embodiment, it may use the same material as the first electrode arrangement 13 or a different material instead, depending on the actual needs. For example, the first electrode arrangement 13 and the second electrode arrangement 14 can both be made of ITO; or in another example, the first electrode arrangement 13 is made of nano metal wire while the second electrode arrangement 14 is made of ITO.

In the capacitive touch system 100 according to the present embodiment of the invention, the capacitive touch sensor 10 is a capacitive touch panel, the first electrode arrangement 13 is the sensing electrode of the touch panel, the second electrode arrangement 14 is the driving electrode of the touch panel, and the floating electrode arrangement 15 is the dummy electrode. An electric field is produced between the first electrode arrangement 13 and the second electrode arrangement 14, and the electric field passes through the insulation slits 15a, 15b. Because of the insulation slits 15a, 15b, the second electrode arrangement 14 is not fully covered by the first electrode arrangement 13 and the floating electrode arrangement 15, and thus the driving signal of the second electrode arrangement 14 is not affected thereby. Also, the sensing signal of the first electrode arrangement 13 is therefore not affected by other signal levels. In this embodiment, other signal levels include but not limit to a grounded or a non-driven second electrode in the second electrode arrangement 14, and a grounded or non-driven first electrode in the first electrode arrangement 13.

When the touch sensor 10 is touched by a user's finger or a capacitive stylus, a change in the characteristic of the electric field occurs; for example, the intensity or the field pattern of the electric field changes. The controller 30 then acquires the touch location base on the change in the characteristic of the electric field, and outputs a control signal afterwards. The electronic device that uses the capacitive touch system 100 as its input means could perform following operations upon receiving the control signal at its CPU. The above-mentioned following operations include changing the display content or launching applications, and will not give more detail hereinafter.

In order to further elaborate the relations of the insulation slits 15a, 15b and the electric field according to the present embodiment of the invention, a capacitive touch circuit is taken as an example in the following descriptions.

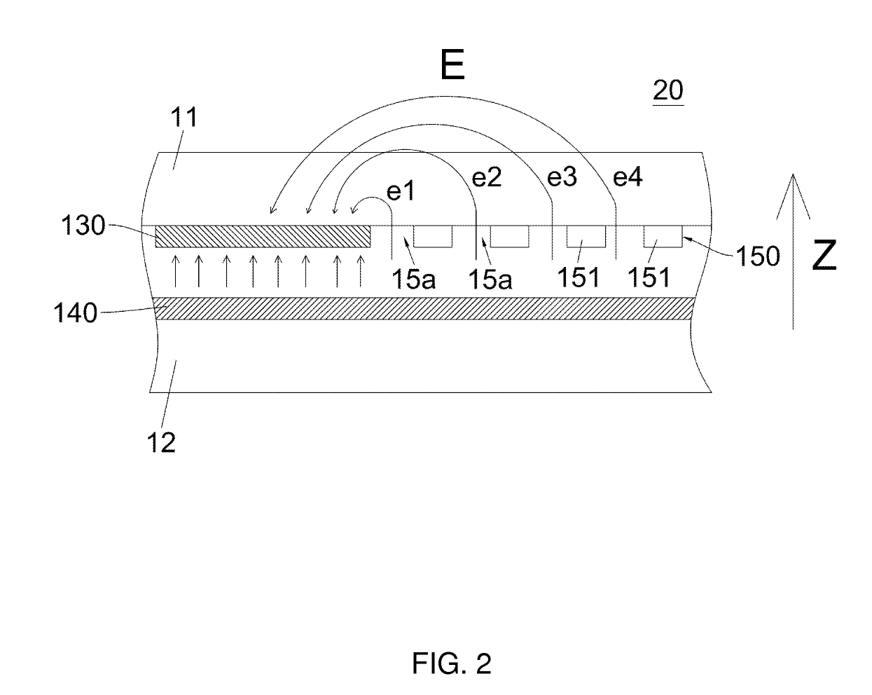

Please refer to FIG. 2, which is a partial side-view of the capacitive touch circuit according to one embodiment of the invention. FIG. 2 shows a part of a lateral side of the capacitive sensor 10 in FIG. 1. Although the capacitive touch circuit 20 shown in FIG. 2 only includes one first electrode 130, one second electrode 140 and one floating electrode 150, it is intended to clearly show the features of the present embodiment, not to limit the scope of the invention. In fact, the first electrode arrangement 13 including multiple first electrodes 130, the second electrode arrangement 14 including multiple second electrode 140, and the floating electrode arrangement 15 including multiple floating electrodes 150, as shown in FIG. 1, can also be regarded as a capacitive touch circuit. Therefore, it is to be understood that the numbers of the first electrode 130, the second electrode 140 and the floating electrode 150 are not limited in the present invention.

As shown in FIG. 2, the capacitive touch circuit 20 of the present embodiment includes the first electrode 130, the second electrode 140 and the floating electrode 150. The first electrode 130 is disposed on a part of the surface of the first substrate 11. The second electrode 140 is disposed on a part of the surface of the second substrate 12 and is used to produce the electric field E with the first electrode 130. The floating electrode 150 is disposed on another part of the surface of the first substrate 11 and at least partially overlaps the second electrode 140 in the projection direction Z. In the present embodiment, the first substrate 11 and the second substrate 12 are disposed in parallel, and the projection direction Z is the upright direction of the first substrate 11 and the second substrate 12, which is similar to the description accompanying FIG. 1.

The floating electrode 150 has at least one insulation slit 15a that the floating electrode 150 and the first electrode 130 are electrically insulated therefrom. The floating electrode 150 includes a number of floating electrode units 151, and these floating electrode units 151 are also electrically insulated from one another through the insulation slits 15a. In the present embodiment with reference to FIG. 2, the electric field E is projected upwardly from the second electrode 140, and is projected toward not only the bottom side of the first electrode 130 but also the top side of the first electrode 130 through the insulation slits 15a. When the capacitive touch circuit 20 is touched by one or more fingers or styli, a change in the characteristic of the electric field E that passes through the insulation slits 15a occurs, and the capacitance between the first electrode 130 and the second electrode 140 changes accordingly. The touch location can therefore be acquired and the following operations can be performed accordingly.

In one embodiment, the first electrode 130 and the floating electrode 150 are made of a same conductive material, and are formed on the first substrate 11 in the same manufacturing step. The conductive material is a transparent conductive material, which can be exemplified by (but not limit to) nano metal wire, Indium Tin Oxide (ITO), Zinc Oxide (ZnO), Indium Zinc Oxide (IZO), Aluminum Zinc Oxide (AZO), Gallium Zinc Oxide (GZO), or nano carbon tubes. On the other hand, the conductive material can also be opaque materials, for example high electrical conductivity metal like silver, copper, and gold. Here in the present embodiment of the invention, the transparent material is preferable for the conductive material. The insulation slits 15a are formed by dry etching; for example, laser cutting the transparent conductive material to form the first electrode 130 and the floating electrode 150. As for the material of the second electrode 140, it may be the same material as the first electrode 130 or a different material instead, depending on actual needs.

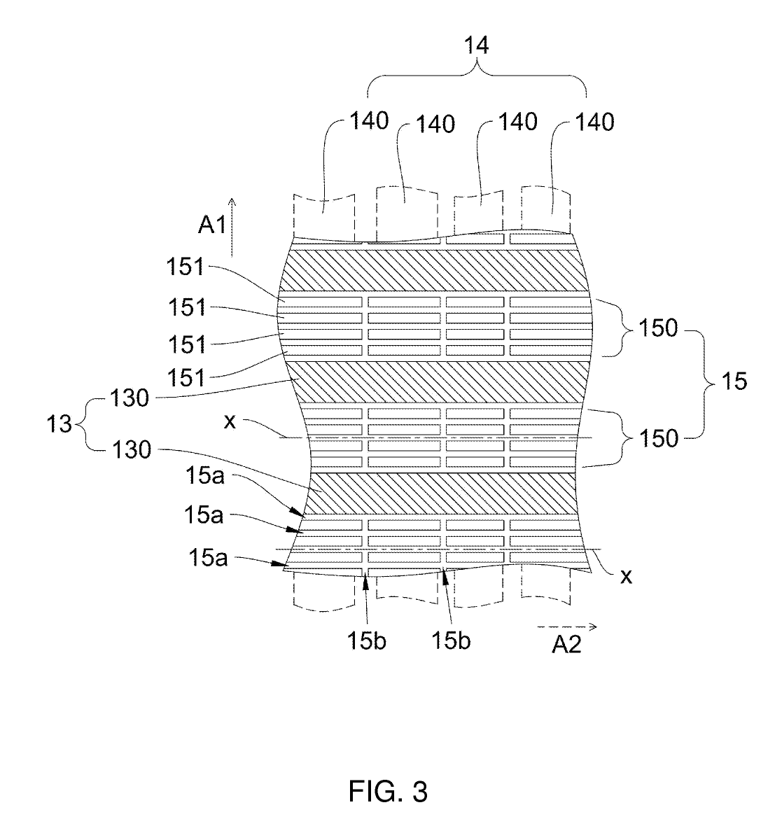

The shapes, numbers, and arrangements of the insulation slits 15a, 15b (slits 15b are not shown in FIG. 2) and the floating electrodes 151 can be embodied in various ways. One of the examples is elaborated in the below with reference to FIG. 1 and FIG. 3 at the same time. FIG. 3 is a partial top-view of the first electrode arrangement and the floating arrangement of FIG. 1. The area of the first electrode arrangement and the floating electrode arrangement shown in FIG. 3 corresponds to a capture area C in FIG. 1.

Among the insulation slits 15a, 15b, the part of the insulation slits 15a situates in a first position, and the part of the insulation slits 15b situates in a second position. The insulation slits 15a in the first position are located between two adjacent first electrodes 130, and partially overlap the second electrode 140. The insulation slits 15b in the second position are located between two adjacent second electrodes 140 as being viewed in the projection direction Z (as shown in FIG. 1), and the slits 15b do not overlap any of the second electrodes 140. The floating electrode arrangement 15 is electrically insulated from the first electrode arrangement 13 through the insulation slits 15a in the first position. The floating electrode units 151 are electrically insulated from one another through both the insulation slits 15a in the first portion and the insulation slit 15b in the second position. The floating electrode arrangement 15 partially overlaps the second electrode arrangement 14 in the projection direction Z.

In the present embodiment, the first electrode arrangement 13, the second electrode arrangement 14 and the floating electrode arrangement 15 are exemplified by stripes. Each floating electrode 150 in the floating electrode arrangement 15 has a central axis X. The floating electrode units 151 of each floating electrode 150 are arranged symmetrically along the central axis X. The first electrodes 130 in the first electrode arrangement 13 are arranged sequentially along a first axial direction A1, and the second electrodes 140 in the second electrode arrangement 14 are arranged sequentially along a second axial direction A2. The second axial direction A2 is parallel to the central axis X but not parallel to the first axial direction A1. The two axial directions A1, A2 are exemplified by perpendicular to each other in the present embodiment. However, the invention is not limited to such perpendicular formation. As long as the first axial direction A1 is not parallel to the second axial direction A2 so that the first and the second electrode arrangement 13, 14 constitute a cross-over formation, it falls within the scope of the invention. Additionally, in another optional embodiment, the floating electrode units 151 are provided with the same area size with one another.

On the other hand, the floating electrode units 151 can also be arranged in accordance with the electric field intensity gradient, so that the electric field would have different intensities when it passes through adjacent insulation slits in the first position 15a. Take the embodiment shown in FIG. 2 as an example. The electric field portion e1 of the electric filed E, which is the closest portion to the first electrode 130, has an intensity larger than the electric field portion e2, which is the second close to the first electrode 130. The rest can be analogized that the intensity of portion e2 is greater than portion e3 and portion e4 in turn. In other words, the intensity of the electric field E passing through the insulation slits 15a decreases gradually in proportion with the increment of distance from the first electrode 130. Therefore, the insulation slits 15a can also be exemplified by etching in accordance with the intensity distribution of the electric field E.

In the embodiment shown in FIG. 3, each insulation slit 15b in the second position is situated between two adjacent second electrodes 140 of the second electrode arrangement 14, and does not overlap anyone of the second electrodes 140 in the projection direction Z (the direction Z is shown in FIG. 1). This means, the insulation slits 15b in the second position are totally free from overlapping the second electrode arrangement 14. As a result, the problems of affecting the signal levels (and the electric field E accordingly) when the second electrode arrangement 14 is grounded or in a non-driven state can be avoided. This decreases the interference that arises from the un-driven first electrode 130 and the second electrode 140 to the touch sensing signal.

In the above-mentioned embodiments, the first electrode arrangement 13, the second electrode arrangement 14 and the floating electrode arrangement 15 are exemplified by stripes, as shown in FIG. 1 to FIG. 3. However, the shapes of these electrode arrangements 13, 14 and 15 are not limited thereto.

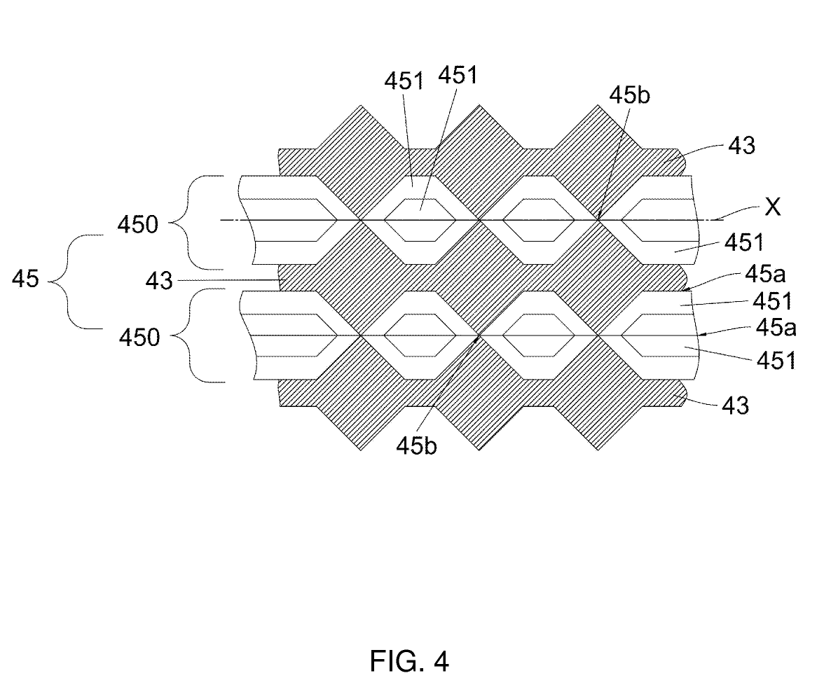

Please refer to FIG. 4, which is a partial top-view of the first electrode arrangement and the floating electrode arrangement according to another embodiment of the invention. The floating electrode arrangement 45 and the first electrode arrangement 43 are electrically insulated from each other through the insulation slits 45a. Practically, the floating electrode arrangement 45 includes more than one floating electrodes 450. (Although only two floating electrodes 450 are shown in FIG. 4, the number of the electrode is not limited in the present invention.) Each floating electrode 450 includes a number of floating electrode units 451, and that they are electrically insulated from one another though the insulation slits 45a, 45b. In the present embodiment, the first electrode arrangement 43 exemplary includes a number of rhombus (or diamond-shape) units. Each floating electrode 450 of the floating electrode arrangement 45 has a central axis X, and the floating electrode units 451 are arranged symmetrically along the central axis X. It should be noted that the area sizes of the floating electrode units 451 are not the same in FIG. 4; however, during the manufacturing process of the floating electrode units 451 (for example, laser cutting a silver metal layer to form the first electrode arrangement 43, the floating electrode arrangement 45, and the floating electrode units 451), the etching pattern can be adjusted so the floating electrode units 451 would have the same area size with corresponding shapes. Moreover, each insulation slit 45b in the second position of the present embodiment is located between two adjacent second electrodes 140 of the second electrode arrangement 14, and does not overlap anyone of the second electrodes 140 in the projection direction Z. (The second electrode arrangement 14, the second electrodes 140, and the projection direction Z are shown in FIG. 1.)

The embodiments of the invention disclose a capacitive touch circuit, a capacitive touch sensor and a capacitive touch system. In the embodiments, the electric field passes through multiple insulation slits, so that the phenomena of the signals (like driving signal or sensing signal) being affected by other signal levels or by different layers of signals could be eliminated. The problems of inaccurate reading of the touch signal and decreasing the accuracy of determining the touch location could be solved accordingly. Although the floating electrode units are exemplified by symmetrical disposition and identical area size in the embodiments, the features of the invention is not limited thereto; in fact, any other arrangements, in which the touch signal is detected by utilizing an electric field passing through the insulation slits, shall be regarded as falling within the scope of the invention.

It will be apparent to those skilled in the art that various modifications and variations can be made to the structure of the present invention without departing from the scope or spirit of the invention. In view of the foregoing, it is intended that the present invention covers modifications and variations of this invention, provided they fall within the scope of the following claims.

What is claimed is:

1. A capacitive touch circuit, comprising:
a first electrode disposed on a partial surface of a first substrate;
a second electrode disposed on a partial surface of a second substrate for producing an electric field with the first electrode; and
a floating electrode disposed on another partial surface of the first substrate and at least partially overlapping the second electrode in a projection direction, and the floating electrode having at least one insulation slit through which the floating electrode is electrically insulated from the first electrode, and the floating electrode comprising:
a plurality of floating electrode units that are electrically insulated from one another through the at least one insulation slit, and the electric field passing through the at least one insulation slit.

2. The capacitive touch circuit of claim 1, wherein the floating electrode units are arranged symmetrically along a central axis of the floating electrode.

3. The capacitive touch circuit of claim 2, wherein a plurality of said first electrodes are arranged sequentially along a first axial direction and a plurality of said second electrodes are arranged sequentially along a second axial direction respectively, and wherein the first axial direction is not parallel to the second axial direction and the second axial direction is parallel to the central axis.

4. The capacitive touch circuit of claim 1, wherein the floating electrode units have the same area size with one another.

5. The capacitive touch circuit of claim 1, wherein the floating electrode has a plurality of said insulation slits, and the intensity of the electric field passing through adjacent insulation slits are different.

6. The capacitive touch circuit of claim 1, wherein the at least one insulation slit is formed by dry etching.

7. The capacitive touch circuit of claim 1, wherein the first electrode and the floating electrode are made of a same conductive material.

8. The capacitive touch circuit of claim 7, wherein the conductive material is Indium Tin Oxide (ITO), Zinc Oxide (ZnO), Indium Zinc Oxide (IZO), Aluminum Zinc Oxide (AZO), Gallium Zinc Oxide (GZO), nano metal wire, nano carbon tubes, silver, copper, or gold.

9. The capacitive touch circuit of claim 7, wherein the first electrode and the second electrode are made of different materials.

10. The capacitive touch circuit of claim 1, wherein the floating electrode has a plurality of said insulation slits, and a part of the insulation slits does not overlap the second electrode in the projection direction.

11. A capacitive touch sensor, comprising:
a first substrate having a first surface;
a first electrode arrangement disposed on a part of the first surface;
a second substrate having a second surface facing the first substrate;
a second electrode arrangement disposed on the second surface for producing an electric field with the first electrode arrangement; and
a floating electrode arrangement disposed on another part of the first surface and at least partially overlapping the second electrode arrangement in a projection direction, and the floating electrode arrangement having a plurality of insulation slits through which the floating electrode arrangement is electrically insulated from the first electrode arrangement, and each floating electrode in the floating electrode arrangement comprising:
a plurality of floating electrode units that are electrically insulated from one another through the insulation slits, and the electric field passing through the insulation slits.

12. The capacitive touch sensor of claim 11, wherein the floating electrode units are arranged symmetrically along a central axis of each floating electrode.

13. The capacitive touch sensor of claim 12, wherein a plurality of first electrodes in the first electrode arrangement are arranged sequentially along a first axial direction and a plurality of second electrodes in the second electrode arrangement are arranged sequentially along a second axial direction, and wherein the first axial direction is not parallel to the second axial direction and the second axial direction is parallel to the central axis.

14. The capacitive touch sensor of claim 11, wherein the floating electrode units have the same area size with one another.

15. The capacitive touch sensor of claim 11, wherein the intensities of the electric field passing through adjacent insulation slits are different.

16. The capacitive touch sensor of claim 11, wherein the insulation slits are formed by dry etching.

17. The capacitive touch sensor of claim 11, wherein the first electrode arrangement and the floating electrode arrangement are made of a same conductive material.

18. The capacitive touch sensor of claim 17, wherein the conductive material is Indium Tin Oxide (ITO), Zinc Oxide (ZnO), Indium Zinc Oxide (IZO), Aluminum Zinc Oxide (AZO), Gallium Zinc Oxide (GZO), nano metal wire, nano carbon tubes, silver, copper, or gold.

19. The capacitive touch sensor of claim 17, wherein the first electrode arrangement and the second electrode arrangement are made of different materials.

20. The capacitive touch sensor of claim 11, wherein a part of the insulation slits does not overlap the second electrode arrangement in the projection direction.

21. A capacitive touch system, comprising:
a capacitive touch sensor, comprising:
a first substrate having a first substrate;
a first electrode arrangement disposed on a part of the first surface;
a second substrate having a second substrate facing the first substrate;
a second electrode arrangement disposed on the second surface for producing an electric field with the first electrode arrangement, wherein when the capacitive touch sensor is touched, a change in the characteristic of the electric field occurs; and
a floating electrode arrangement disposed on another part of the first surface and at least partially overlapping the second electrode arrangement in a projection direction, and the floating electrode arrangement having a plurality of insulation slits through which the floating electrode arrangement is electrically insulated from the first electrode arrangement, and the floating electrode arrangement comprising:
a plurality of floating electrode units that are electrically insulated from one another through the insulation slits, and the electric field passing through the insulation slits; and
a controller electrically connected to the capacitive touch sensor for outputting a control signal based on the change in the characteristic of the electric field.
